(19) United States
(12) Patent Application Publication
(10) Pub. No.: US 2005/0268122 A1
(43) Pub. Date: Dec. 1, 2005

(54) Devices and methods for validating network connections

(76) Inventors: Brian R. Young, Raleigh, NC (US); James G. Thompson, Raleigh, NC (US)

Correspondence Address: Elizabeth A. Stanek;Myers Bigel Sibley & Sajovec, P.A., Post Office Box 37428, Raleigh, NC, 27627, US

(21) Appl. No.: 10/857,063

(22) Filed: May 28, 2004

(51) Int. Cl. G06F 1/30

(52) U.S. Cl. 713/300

(57) ABSTRACT

Methods, devices and computer program products for verifying a network connection of a network-enabled device, for example, a power supply, are provided. A target device identifier of a target device on the network is provided at the network-enabled device. A signal is transmitted to the target device from the network-enabled device to determine if a connection exists between the network-enabled device and the target device. An indication of the connection is ascertained responsive to the transmitted signal.

### BACKGROUND OF THE INVENTION

The present invention relates to network-enabled devices and methods of operation thereof, and more particularly, to network-enabled uninterruptible power supplies (UPSs) and methods of operation thereof.

With an increased reliance on electronic devices and electronic methods of communication, more and more devices are being configured to connect to communications networks. For example, many power distribution devices, such as, uninterruptible power supplies (UPSs), are configured to connect to a communications network. UPSs are commonly used to provide conditioned and/or auxiliary power to electronic equipment that provides critical functions, such as computer systems, telecommunications systems and medical equipment. Typically, UPSs can provide AC power from a backup source, such as a battery, generator or fuel cell, in the event that a utility power supply fails or becomes degraded. Network-enabling a UPS may allow the UPS to be remotely monitored to determine the state of the UPS.

Conventional network-enabled devices typically contain circuitry that allows the device to connect to and be managed from the Ethernet. During installation of these devices, the user generally configures the network-enabled device with information, such as an Internet protocol (IP) address, network gateway, network mask and other addresses, which typically depend on the types of service provided by the device or connection. Once the device is configured, the user typically relies on connecting to the device via a separate external networked computer to verify that the device is truly visible on the network and configured properly for use.

### SUMMARY OF THE INVENTION

Some embodiments of the present invention provide methods, devices and computer program products for verifying a network connection of a network-enabled device, for example, a power supply. A target device identifier of a target device on the network is provided at the network-enabled device. A signal is transmitted to the target device from the network-enabled device to determine if a connection exists between the network-enabled device and the target device. An indication of the connection is ascertained responsive to the transmitted signal.

In further embodiments of the present invention, the ascertained indication may include a response signal indicating that the network-enabled device is reachable from, connectable to and/or connected to the target device. The network-enabled device may connect to the target device to determine if connection to the target device is possible. The transmission of the signal and the ascertaining of the indication may be repeated to ensure a valid connection between the network-enabled device and the target device.

In still further embodiments of the present invention, the ascertained indication may include not receiving a response signal indicating that the network-enabled device is not reachable from, connectable to and/or connected to the target device. If the response signal is not ascertained, a target device may be de-energized and re-energized. A second signal may then be transmitted to a target device from the network-enabled device to determine if a connection exists between the network-enabled device and the target device and an indication of the connection may be ascertained responsive to the transmitted second signal. In certain embodiments of the present invention, the target device identifier comprises at least one of an Internet protocol (IP) address of the target device and a host name of the target device.

While the present invention is described above primarily with reference to methods, devices and computer program products for verifying a network connection of a network enabled device are also provided herein.

### BRIEF DESCRIPTION OF THE DRAWINGS

FIG. 1 is a block diagram of a data processing system suitable for use in some embodiments of the present invention.

FIG. 2 is a block diagram of a communications circuit according to further embodiments of the present invention.

FIG. 3 is a block diagram illustrating still further embodiments of the present invention illustrated in an exemplary network environment.

FIG. 4 is a flowchart illustrating exemplary operations of devices for verifying a network connection according to some embodiments of the invention.

FIG. 5 is a flowchart illustrating exemplary operations of devices for verifying a network connection according to further embodiments of the invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as a method, device, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described in part below with reference to flow chart illustrations and/or block diagrams of methods, devices and computer program products according to embodiments of the invention. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flow chart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flow chart and/or block diagram block or blocks.

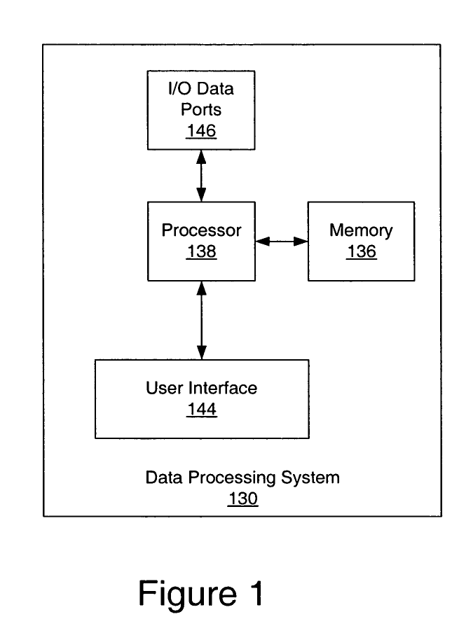

Embodiments of the present invention will now be described with respect to FIGS. 1 through 5. As discussed herein, embodiments of the present invention provide devices, methods and computer program products for verifying a network connection of a network-enabled device, for example, an uninterruptible power supply (UPS). In some embodiments of the present invention, a communications validator circuit is provided that is configured to transmit a signal from the network-enabled device to a target device identified by a target device identifier, for example, an Internet protocol (IP) address or host name, to determine if a connection exists between the network-enabled device and the target device. The network-enabled device may ascertain an indication of the connection responsive to the transmitted signal, i.e., a response signal from the target device may be ascertained or no response signal from the target device may be ascertained. If a response is ascertained, in some embodiments of the present invention, the communications validator circuit may be further configured to connect the network-enabled device to the target device to determine if connection to the target device is actually possible. If it is determined that connection is not possible or that no response signal has been ascertained, the target device may be de-energized and re-energized to attempt to recover the device from failure. Accordingly, connections between a network-enabled device and a target device on the network may be verified from the network-enabled device, thus, removing the necessity to move from one target device to another to test the configuration of the network connections.

FIG. 1 illustrates an exemplary embodiment of a data processing system 130 configured in accordance with embodiments of the present invention. The data processing system 130, which may be incorporated in, for example, a personal computer, server, power supply, e.g., a UPS or the like, may include a user interface 144, for example, input device(s) such as a keyboard or keypad, a display, a speaker and/or microphone, and a memory 136 that communicate with a processor 138. The data processing system 130 may further include an I/O data port(s) 146 that also communicates with the processor 138. The I/O data ports 146 can be used to transfer information between the data processing system 130 and another computer system or a network using an Internet protocol (IP) connection. These components may be conventional components such as those used in many conventional data processing systems, which may be configured to operate as described herein.

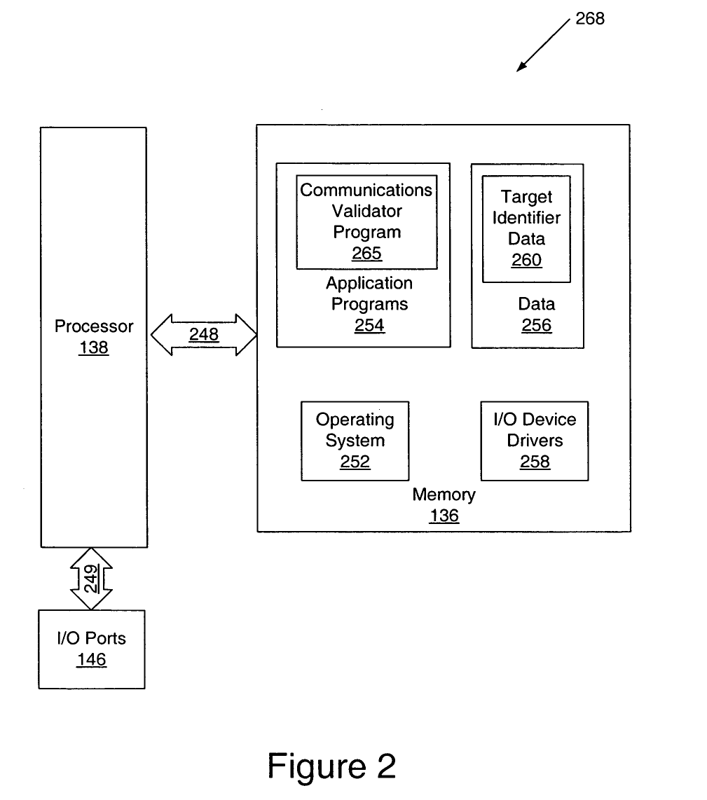

Referring now to FIG. 2, a block diagram of a communications validator circuit 268 that illustrates devices, methods, and computer program products in accordance with embodiments of the present invention will be discussed. The processor 138 communicates with the memory 136 via an address/data bus 248. The processor 138 can be any commercially available or custom microprocessor, microcontroller, digital signal processor or the like. The memory 136 may include any memory devices containing the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the communications validator circuit 268: an operating system 252; application programs 254; input/output (I/O) device drivers 258; and data 256. As will be appreciated by those of skill in the art, the operating system 252 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the communications circuit 268 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

As further illustrated in FIG. 2, according to some embodiments of the present invention the application programs 254 include a communications validator program 265 and the data 256 includes target device identifier data 260. The communications validator circuit 268 may be configured to transmit a signal, for example, a ping signal, to a target device on the communications network identified by a target device identifier, for example, an Internet protocol (IP) address or a host name. The target device identifier may be stored in the target device identifier data 260 of the data 256. As used herein, a “target device” refers to a device on a network that may be connected to a network-enabled device, for example, a UPS, over the network, for example, a server, a router, a hub and the like. The signal may be transmitted from a network-enabled device to determine if a connection exists between the network-enabled device and the target device. The communications validator program 265 may be further configured to ascertain an indication of the connection responsive to the transmitted signal. In other words, if the target device receives the transmitted signal, for example, the ping signal, the communications validator program may receive a response signal from the target device, for example, a pong signal or an echo, to indicate that the ping signal was received at the target device. On the other hand, if the target device does not receive the transmitted signal, no response signal will be received from the target device. Accordingly, the indication ascertained may be a response signal or the absence of the response signal.

If a response signal is received from the target device, the communications validator program 265 may be further configured to attempt to connect the network-enabled device to the target device to determine if connection is possible. In other words, just because a communication link between the network-enabled device and the target device is there does not mean that the network-enabled device will actually be able to connect to the target device. The communications validator program 265 may be further configured to transmit the ping signal multiple times, even if a response signal is received from the target device to ensure a proper connection has been established.

If a response signal is not received from the target device, the communications validator program 265 may be further configured de-energize and re-energize the target device. After the target device has been re-energized, the communications validator program 265 may be configured to transmit a second signal, for example, a ping signal, to the target device and receive to determine if the target device has recovered from failure.

Additional aspects of the data 256 in accordance with embodiments of the present invention are illustrated in FIG. 2. As illustrated in FIG. 2, the data 256 may include target identifier data 260. This portion of the data 256 may include a list of target device identifiers identifying target devices on the network. The communications validator program 256 may used the list of target device identifiers to determine which devices to verify.

While the present invention is illustrated with reference to the communications validator program 265 being an application program in FIG. 2, as will be appreciated by those of skill in the art, other configurations fall within the scope of the present invention. For example, rather than being an application program, the communications validator program 265 may also be incorporated into the operating system 252 or other such logical division of the data processing system 130. Furthermore, while the communications validator program 265 is illustrated in a single data processing system, as will be appreciated by those of skill in the art, such functionality may be distributed across one or more data processing systems. Thus, the present invention should not be construed as limited to the configuration illustrated in FIGS. 1 through 2, but may be provided by other arrangements and/or divisions of function between data processing systems.

Some embodiments of the present invention may be included on a network card, module or other circuit assembly configured to be installed in a network-enabled device. For example, the present invention may be embodied in a network card similar to a ConnectUPS Web/SNMP Card offered by Powerware Corporation of Delaware, the assignee of the present application. The ConnectUPS Web/SNMP Card is configured to install in a UPS to provide simple network management protocol (SNMP), hypertext transfer protocol (HTTP), simple mail transfer protocol (SMTP), wireless application protocol (WAP) and Telnet compatibility and advanced RS-232 communications. The network card may allow monitoring, management and safe shut down or re-boot of UPS-protected devices, for example, servers, routers, hubs and other key inter-networking devices in a controlled manner. ConnectUPS Web/SNMP cards provide a link between the UPS and, for example, the Ethernet local area/wide area network (LAN/WAN), allowing the UPS to be remotely monitored and controlled.

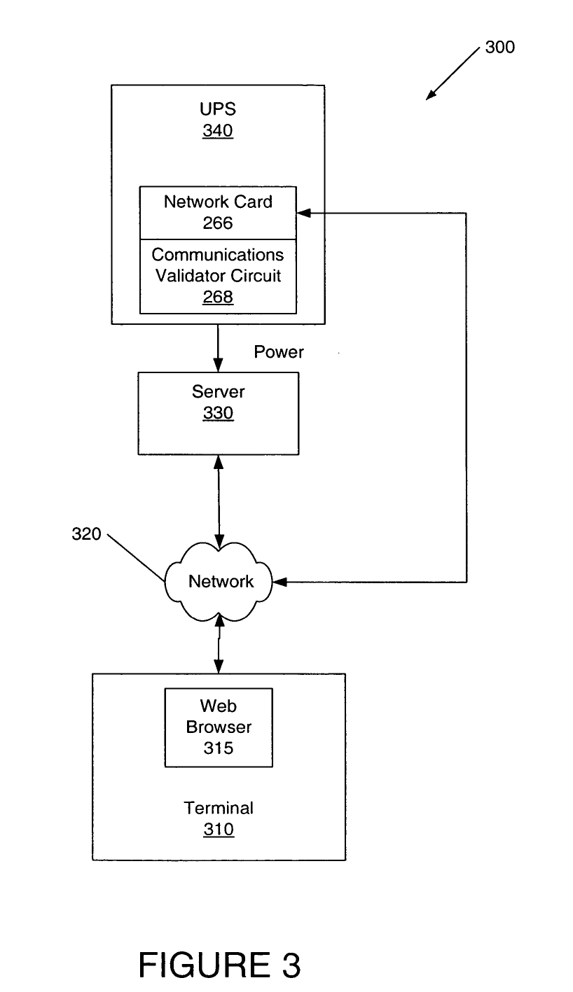

Referring now to FIG. 3, a network environment 300 according to some embodiments of the present invention may include a terminal 310, a network 320, a server 330, and a network-enabled device, for example, UPS 340. The terminal 310 may be, for example, a laptop computer, a desktop computer, a personal data assistant (PDA), a web capable mobile terminal or any device capable of communicating with the network 320. As illustrated, the terminal 310 may be configured to run a web browser 315. The terminal 310 may communicate over the network 320, for example, the internet, through, for example, a telephone line, a digital subscriber link (DSL), a broadband cable link, a wireless link or the like. The server 330 may also communicate over the network 320. It will be understood that the server 330 may be an application server, for example, a mail server, a web server or the like without departing from the scope of the present invention.

As further illustrated, the UPS 340 provides power to the server 330 and includes a network card 266, for example, the ConnectUPS Web/SNMP Card discussed above, that communicates with the network 320. The network card 266 may include a communications validator circuit 268 according to some embodiments of the present invention. It will be understood that the network environment illustrated in FIG. 3 is provided for exemplary purposes only and that the invention is not limited to this configuration. For example, the system illustrated in FIG. 3 may include one or more terminals 310, networks 320, servers 330 and/or UPSs 340 without departing from the scope of the present invention. Furthermore, the communications validator circuit 268 may be included in the UPS 340 without being included on the network card 266.

Exemplary operations of the present invention will now be discussed with respect to FIGS. 1 through 3. During installation of the UPS 340, an installer may select a network test menu option displayed on the browser 315 running on the terminal 310. Upon selection of the network test option, the installer may be presented with a submenu containing 2 options, a Simple Ping Test option and an Enhanced Ping and Connection Test option. The display may be a text display or a graphical user interface (GUI) without departing from the scope of the present invention. If the installer selects the Simple Ping Test option, the communication circuit 265 may prompt the installer to “Enter the IP Address or Host Name to Ping.” At this point, the installer may enter the IP address of the server 330 so as to identify the server 330 as the object of the test. In some embodiments of the present invention, a list of target device identifiers corresponding to target devices on the network 320 may be stored in the memory 136, for example, target device data 260. The communications validator circuit 268 may be configured to verify a network connection between UPS 340 and each target device associated with a target device identifier on the list.

Upon entering an IP address (or host name), the communications validator circuit 268 may transmit a signal, for example, a ping signal, to the device at the IP address that has been provided, for example, server 330. In other words, the communications validator circuit 268 transmits a signal or signals, for example, packets, to the server 330 requesting a response from the server 330. In some embodiments of the present invention, the communications validator program may ping the server 330 multiple times, for example, four times. The communications validator circuit 268 waits to receive a return signal, i.e., a pong signal or an echo signal, from the server 330. In some embodiments of the present invention, the communications validator circuit 268 may be configured to repeat sending the signal and waiting for a response signal from the server 330 to ensure that the connection between the UPS 340 and the server 330 is valid and operational.

If the installer has selected the enhanced test, the communications validator circuit 268 may perform a more detailed ping test and may attempt to connect to the server 330 to ensure that the UPS 340 can connect to the server 330 if a return signal is received at the communications validator circuit 268. In particular, a series of tests on the IP addresses and/or host names may be provided to the communications validator circuit 268 to configure the network card 266. Upon selecting this test, the installer may be prompted to enter (Y)es to initiate the test as No is the default. At this point the communications validator circuit 268 may be configured to proceed through the test set out in Table 1 below.

TABLE 1

| Test | Possible Responses | Notes |
|---|---|---|
| Ping DNS | Not Configured | Not Configured means it's still |
| Server | Ping OK | at 0.0.0.0. |
| | No Response | |
| Ping Gateway | Not Configured | Not Configured means it's still |
| | Ping OK | at 0.0.0.0. |
| | No Response | |
| Ping SMTP | Not Configured | Not Configured means it's still |
| Server | Ping OK | at 0.0.0.0. |
| | No Response | |
| Connect to | Not Configured | Use the port number as set by |
| SMTP Server | Connection OK | the user, along with the optional |
| | Connection Failed | SMTP username and password |
| | | and substitute domain name for |
| | | sender's email address if |
| | | configured. |
| | Ignore Test | (When “Not Configured” is |
| | | configured in “Ping SMTP |
| | | Server” test) |
| Ping POP3 | Not Configured | Not Configured means that it's |
| | Ping OK | still at 0.0.0.0. |
| | No Response | |
| Connect to | Not Configured | Must use the port number as set |
| POP3 Server | Authentication OK | by the user, along with the |
| | Authentication Failed | username and password. |
| | Ignore Test | (Ignore Test -- When “Not |
| | | Configured” is detected in “Ping |
| | | POP3 Server” test) |
| | BUSY | (BUSY -- When webcard |
| | | executes the regular POP3 |
| | | function) |
| Ping Date | Not Configured | Not Configured means that it's |
| Server 1 | Ping OK | still at 0.0.0.0. |
| | No Response | |
| Ping Date | Not Configured | Not Configured means that it's |
| Server 2 | Ping OK | still at 0.0.0.0. |
| | No Response | |
| Ping SNMP | Entry [n] Not | Ping all configured IP |
| Access List | Configured | addresses, but avoid pinging the |
| | Entry [n] Ping OK | entries 1 and 2 if they are still at |
| | Entry [n] No Response | 255.255.255.255. Valid entries |
| | | are n = 1 to 8. |
| | Ignore Test | (When the IP is |
| | | 255.255.255.255) |

If, on the other hand, a return signal is not received from the server 330 responsive to the transmitted signal, the connection may not be configured. At this point, the communications validator circuit 268 may be configured to de-energize and re-energize the server 330 to possibly correct the configuration problem between the UPS 340 and the server 330. Once the server 330 is re-energized, the communications validator circuit 268 may be configured to transmit a second signal, for example, a ping signal, to the server 330 to determine if the connection will now be established. Again, if the communications validator circuit 268 receives a response signal, the connection has been verified. If, on the other hand, no response signal is received, the connection may still not have been established.

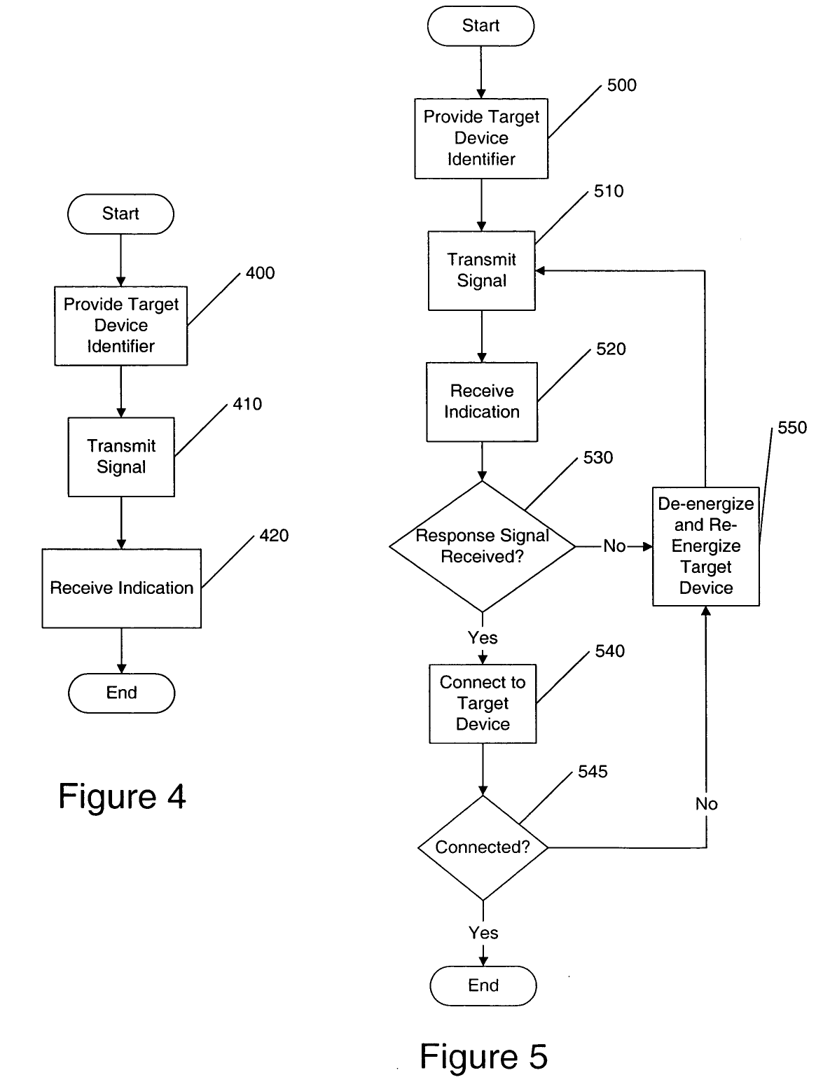

It will be understood that the example discussed above with respect to FIGS. 1 through 3 is not intended to limit embodiments of the present invention and is provided for exemplary purposes only. Operations according to embodiments of the present invention may include additional steps or omit steps discussed above without departing from the teachings of the present invention. Furthermore, the steps may be combined or performed in a different order than discussed above. Operations of a communication circuit according to embodiments of the present invention will now be discussed further with respect to the flowcharts of FIGS. 4 and 5.

Referring now to FIG. 4, operations begin at block 400 by providing a target device identifier, for example, an IP address or a host name. The target device may be, for example, a server, a router or the like. As discussed above, the target device identifier may be entered by, for example, an installer, or a list of target device identifiers corresponding target devices may be provided in a list. A signal, for example, a ping signal, may be transmitted to the target device identified by the target device identifier (block 410). The signal may be transmitted to the target device to determine if a connection exists between a network-enabled device, for example, a power supply, and the target device. An indication of the connection may be received responsive to the transmitted signal (block 420). If the transmitted signal is received by the target device, the indication of the connection may be a response signal, for example, an echo or pong signal. If, on the other hand, the transmitted signal is not received by the target device, the indication of the connection may be a lack of response from the target device.

Referring now to FIG. 5, operations begin at block 500 by providing a target device identifier, for example, an IP address or a host name. A signal, for example, a ping signal, may be transmitted to the target device identified by the target device identifier (block 510). The signal may be transmitted to the target device to determine if a connection exists between the network-enabled device, for example, a power supply, and the target device. An indication of the connection may be received responsive to the transmitted signal (block 520). If the transmitted signal is received by the target device, the indication of the connection may be a response signal, for example, an echo or pong signal. If, on the other hand, the transmitted signal is not received by the target device, the indication of the connection may be a lack of response from the target device.

It is determined if a response signal has been received from the target device (block 530). If a response signal has been received (block 530), an attempt is made to connect the network-enabled device to the target device (block 540). It is determined if the network-enabled device was able to connect to the target device (block 545). If the network-enabled device was able to connect to the target device, the connection between the network-enabled device and the target device has been verified. In some embodiments of the present invention, blocks 500 through 540 may be repeated to ensure a properly verified connection. If, on the other hand, the network-enabled device was not able to connect to the target device, the target device may be de-energized and re-energized (block 550) and operations of blocks 510 through 540 may be repeated to verify the connection between the target device and the network-enabled device. If a response to the signal is not received (block 530), the target device may be de-energized and re-energized and operations of blocks 510 through 530 may be repeated to verify the connection between the target device and the network-enabled device.

As briefly discussed above with respect to FIGS. 1 through 5, embodiments of the present invention provide methods, systems and computer program products for verifying network connections of network-enabled devices, for example, UPSs. A signal is transmitted to a target device, for example, a server or a router, identified by a target device identifier, for example, an IP address or a host name, to determine if a connection exists between the network-enabled device and the target device. If a response signal is received from the target device, the network connection may be verified. As part of the verification process, the network-enabled device may be connected to the target device. This process may be repeated to ensure that the connection has been verified. If a response signal is not received from the target device, the target device may be de-energized and re-energized to possibly cure any configuration problems between the network-enabled device and the target device.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of verifying a network connection of a power supply, comprising:
providing a target device identifier of a target device on the network to the power supply;
transmitting a signal to the target device from the power supply to determine if a connection exists between the power supply and the target device;
ascertaining an indication of the connection responsive to the transmitted signal; and
controlling the power supplied to the target device responsive to the ascertained indication.

2. The method of claim 1, wherein the power supply is a uninterruptible power supply (UPS) and wherein the ascertained indication comprises a response signal indicating that the power supply is reachable from, connectable to and/or connected to the target device.

3. The method of claim 2, further comprising connecting the power supply to the target device to determine if connection is possible.

4. The method of claim 2, further comprising repeating the transmitting and the ascertaining to ensure a valid connection between the power supply and the target device.

5. The method of claim 1, wherein the ascertained indication comprises not receiving a response signal indicating that the power supply device is not reachable from, connectable to and/or connected to the target device, wherein the signal comprises a first signal, and wherein controlling the power supplied to the target device comprises:
de-energizing and re-energizing the target device;
transmitting a second signal to the target device from the power supply to determine if a connection exists between the power supply and the target device; and
ascertaining an indication of the connection responsive to the transmitted second signal.

6. A method of verifying a network connection of a network-enabled device, comprising:
providing a target device identifier of a target device on the network to the network-enabled device;
transmitting a signal to the target device from the network-enabled device to determine if a connection exists between the network-enabled device and the target device; and
ascertaining an indication of the connection responsive to the transmitted signal.

7. The method of claim 6, wherein the received indication comprises a response signal indicating that the network-enabled device is reachable from, connectable to and/or connected to the target device.

8. The method of claim 7, further comprising:
connecting the network-enabled device to the target device to determine if connection is possible.

9. The method of claim 7, further comprising repeating the transmitting and the ascertaining to ensure a valid connection between the network-enabled device and the target device.

10. The method of claim 6, wherein the received indication comprises not receiving a response signal indicating that the network-enabled device is not reachable from, connectable to and/or connected to the target device and wherein the signal comprises a first signal, the method further comprising:
de-energizing and re-energizing the target device;
transmitting a second signal to the target device from the network-enabled device to determine if a connection exists between the network-enabled device and the target device; and
ascertaining an indication of the connection responsive to the transmitted second signal.

11. The method of claim 6, wherein the target device identifier comprises at least one of an Internet protocol (IP) address of the target device and a host name of the target device.

12. A network-enabled power supply comprising:
a communications validator circuit configured to transmit a signal to a target device identified by a target device identifier from the network-enabled power supply to determine if a connection exists between the network-enabled power supply and the target device, and ascertain an indication of the connection responsive to the transmitted signal.

13. The power supply of claim 12, further comprising a network circuit assembly installed in the power supply to enable network communications and wherein the communications validator circuit is included on the network circuit assembly.

14. The power supply of claim 12, wherein the ascertained indication comprises not ascertaining a response signal indicating that the network-enabled power supply is not reachable from, connectable to and/or connected to the target device, wherein the signal comprises a first signal and wherein the communications validator circuit program is further configured to:
de-energize and re-energize the target device;
transmit a second signal to the target device from the network-enabled power supply to determine if a connection exists between the network-enabled power supply and the target device; and
ascertain an indication of the connection responsive to the transmitted second signal.

15. The power supply of claim 12, wherein the ascertained indication comprises a response signal indicating that the network-enabled power supply is reachable from, connectable to and/or connected to the target device.

16. The power supply of claim 15, wherein the communications validator program is further configured to connect the network-enabled power supply to the target device to determine if connection is possible.

17. The power supply of claim 15, wherein the communications validator circuit is further configured to repeatedly transmit the signal and ascertain the indication to ensure a valid connection between the network-enabled power supply and the target device.

18. A network-enabled device comprising:
a communications validator circuit configured to transmit a signal to a target device identified by a target device identifier from the network-enabled device to determine if a connection exists between the network-enabled device and the target device, and ascertain an indication of the connection responsive to the transmitted signal.

19. The device of claim 18, wherein the network-enabled device is an uninterruptible power supply (UPS) and wherein the network-enabled device comprises a network circuit assembly installed in the UPS to enable network communications and wherein the communications validator circuit is included on the network circuit assembly.

20. The device of claim 18, wherein the ascertained indication comprises not receiving a response signal indicating that the network-enabled device is not reachable from, connectable to and/or connected to the target device, wherein the signal comprises a first signal and wherein the communications validator circuit is further configured to:
de-energize and re-energize the target device;
transmit a second signal to the target device from the network-enabled device to determine if a connection exists between the network-enabled device and the target device; and
ascertain an indication of the connection responsive to the transmitted second signal.

21. A network circuit assembly installed in a power supply to enable network communications, the network circuit comprising:
a communications validator circuit configured to transmit a signal to a target device identified by a target device identifier from the power supply to determine if a connection exists between the power supply and the target device, and ascertain an indication of the connection responsive to the transmitted signal.

22. The network circuit of claim 21, wherein the ascertained indication comprises a response signal indicating that the power supply is reachable from, connectable to and/or connected to the target device.

23. The network circuit of claim 22, wherein the communications validator program is further configured to connect the power supply to the target device to determine if connection is possible.

24. The network circuit of claim 21, wherein the ascertained indication comprises not receiving a response signal indicating that the power supply is not reachable from, connectable to and/or connected to the target device, wherein the signal comprises a first signal and wherein the communications validator circuit is further configured to:
de-energize and re-energize the target device;
transmit a second signal to the target device from the power supply to determine if a connection exists between the power supply and the target device; and
ascertaining an indication of the connection responsive to the transmitted second signal.

25. A computer program product for verifying a network connection of a power supply, the computer program product comprising:
a computer readable storage medium having computer readable program code embodied in said medium, said computer readable program code comprising:
computer readable program code configured to provide a target device identifier of a target device on the network at the power supply;
computer readable program code configured to transmit a signal to the target device from the power supply to determine if a connection exists between the power supply and the target device; and
computer readable program code configured to ascertain an indication of the connection responsive to the transmitted signal.

26. The computer program product of claim 25, wherein the computer readable program code configured to ascertain the indication comprises computer readable program code configured to ascertain a response signal indicating that the power supply is reachable from, connectable to and/or connected to the target device.

27. The computer program product of claim 26, further comprising computer readable program code configured to connect the power supply to the target device to determine if connection is possible.

28. The computer program product of claim 25, wherein the ascertained indication comprises not receiving a response signal indicating that the power supply is not reachable from, connectable to and/or connected to the target device and wherein the signal comprises a first signal, the computer program product further comprising:
computer readable program code configured to de-energize and re-energize the target device; and
computer readable program code configured to transmit a second signal to the target device from the power supply to determine if a connection exists between the power supply and the target device; and
computer readable program code configured to ascertain an indication of the connection responsive to the transmitted second signal.
